(19) United States
(12) Patent Application Publication
(10) Pub. No.: US 2023/0120837 A1
(43) Pub. Date: Apr. 20, 2023

(54) POLYAMIDE MATERIALS HAVING IMPROVED LONG-TERM PERFORMANCE CHARACTERISTICS

(71) Applicant: L. BRÜGGEMANN GMBH & CO. KG, Heilbronn (DE)

(72) Inventors: Klaus BERGMANN, Heilbronn (DE); Kristina FRÄDRICH, Heilbronn (DE)

(21) Appl. No.: 17/791,647

(22) PCT Filed: Jan. 11, 2021
(86) PCT No.: PCT/EP2021/050391

§ 371 Date: Dec. 16, 2022

(30) Foreign Application Priority Data
Jan. 9, 2020 (EP) 20150881.9

(51) Int. Cl. C08K 13/04; C08L 77/06; C08J 3/20

(52) U.S. Cl. CPC C08K 13/04; C08L 77/06; C08J 3/203; C08K 5/053

(57) ABSTRACT

The present invention relates to a process for the long-term stabilization of polyamides and the use of a specific additive composition for the long-term stabilization of polyamides.

### INVENTION BACKGROUND

The present invention relates to polyamide materials with improved long-term service properties, methods for the long-term stabilization of polyamides, and the use of specific additive compositions for the long-term stabilization of polyamides.

In the presence of atmospheric oxygen, thermooxidative or photooxidative reactions take place on the polyamide surface at temperatures above 70° C. or through high-energy radiation. In this process, the surface yellows and becomes increasingly dull and cracked. This leads to embrittlement of the material and thus to impairment of the mechanical properties of the molded part. By adding suitable stabilizers, the oxidative damage to the polyamide can be delayed, so that the time until embrittlement of the polyamide parts can be postponed.

A distinction is usually made between stabilizers for different temperature ranges. Typical classes of stabilizers for polyamides are copper-based stabilizers, secondary aromatic amines and stabilizers based on sterically hindered phenols. Sterically hindered phenols are usually used in combination with secondary antioxidants, especially phosphites or phosphonates. These blends of sterically hindered phenols with phosphites or phosphonates are referred to below as phenolic stabilizers and phenolic antioxidants, respectively. The copper-based stabilizers typically comprise at least one copper compound and at least one other halogen-containing component, referred to as a synergist. The combination of copper compounds with halogen-containing synergists is hereinafter referred to as a copper stabilizer.

For automotive applications in the engine compartment, housings for controls, connectors and sensors are generally made from polyamide materials, as polyamides can withstand the boundary conditions required there particularly well. The high ambient temperatures to which the assemblies are exposed play an important role here. In this context, increasing miniaturization and the ever tighter packing of components are contributing to a progressive rise in temperature requirements.

In recent years, manufacturers have been increasingly confronted with corrosion problems, especially electrocorrosion, which have resulted in corresponding failures. Analytical studies on corroded contacts showed that iodides and bromides, which were identified as components of the copper-based stabilizers in the polyamide materials used, were significantly involved in the corrosion process.

In order to reliably prevent failures, the demand for copper-free and thus also halogen-free polyamide materials is increasingly emerging. In the field of sensitive automotive electronics, the demand for materials with particularly low copper and halogen contents has already become widely accepted. At the same time, however, in many applications the polyamide materials should exhibit a stabilization in which the tensile strength at a heat load of 150° C. only drops to 50% after a period of at least 2,000 hours or, depending on the application, even after at least 3,000 hours. These combined requirements (copper-free and also long retention of the mechanical properties at high temperatures) cannot be achieved with the usual stabilization options for aliphatic polyamides (without the use of copper stabilizers), or only with great difficulty. As a result, manufacturers currently have to resort to expensive specialty thermoplastics such as polyphenylene sulfide and partially aromatic polyamides, and are therefore looking for new solutions for essentially aliphatic polyamide materials for electrical applications that exhibit increased performance at high temperatures and do not require the addition of copper and halogen compounds for stabilization.

In the prior art, systems for stabilizing polymers against thermooxidative damage and the resulting molecular degradation already exist for this purpose, which largely dispense with copper-containing and halogen-containing components. The addition of polyalcohols (polyols) or, alternatively, iron compounds to polyamides has been identified as a way of making polyamides suitable for use at temperatures in the range >200° C. as well as in the range from 180° C. to 200° C. However, at temperatures below this (below 200° C. and especially below 180° C.), the effect of the polyols or the iron compounds is only slightly pronounced. It is postulated that these stabilizers do not act as classical antioxidants in polyamides, but that at elevated temperatures in the presence of oxygen they form a protective layer which, as a barrier (“patina”), is not or only slightly permeable to oxygen and thus prevents further oxidation of the underlying polyamide areas.

Since it is necessary for the effectiveness of the polyols or iron compounds that such a barrier layer is formed, a sealing step (annealing step) is mandatory at high temperatures, even if the actual temperature requirements are lower. This concept has been presented as “shielding” or barrier technology in a number of publications as a solution to very high temperature requirements especially in engine and powertrain applications (see: “Superior resistance to thermo-oxidative and chemical degradation in polyamides and polyphthalamides”, Technical Library Society of Plastic Engineers, January 2011, by S. Mok etal.; Dr. Kremers, Apr. 19, 2016 SKZ conference; Dr. Gauge, AMI Performance Polyamides 2017; “Aging resistance maximized” by K. Bender, Kunststoffe 3/2010, pp. 66-70; brochure Ultramid® Endure by BASF). This means that a longer residence time at high temperatures must be given, typically at temperatures of 200° C. and above. However, the requirement for a “sealing step” through appropriate storage at high temperatures severely limits the application possibilities and is a major impediment to using the technology at temperatures below this high temperature range. Moreover, this approach is not possible for unreinforced polyamides, since unreinforced polyamides would be largely destroyed during a sealing step at such high temperatures.

The technology described here, which is based on the formation of a barrier layer at very high temperatures, is currently used for reinforced polyamide materials that are permanently exposed to very high temperatures (>200° C.) in the application. This is the case, for example, with turbochargers, which provide very high pressures and temperatures in the engine compartment, especially in the charge air section. In turbocharged diesel engines, temperatures of up to 240° C. can prevail in the area between the turbocharger and the charge air cooler. In this context, polyamide components are used that are based on polyamide compositions containing “barrier-forming” additives. These are, for example, charge air cooler end caps, resonators and charge air lines.

In the prior art, partially aromatic polyamide compositions containing glass fibers and polyols are described which exhibit significantly improved long-term stability at very high temperatures. WO2010/014785 A1 discloses partially aromatic polyamides reinforced with glass fibers for the high-temperature range, which additionally contain polyols and secondary aromatic amines or sterically hindered amines (or combinations of these two substance classes). A solution for unreinforced polyamide compositions in the low-temperature range has not yet been disclosed.

Another possibility for stabilizing polyamides in the temperature range above 180° C. is described in EP2641932A1 and in EP2828322. By adding iron salts, e.g. iron oxalate, alone or in combination with another thermostabilizer such as a copper salt-based additive, the retention times in the high-temperature range can be significantly extended. A high-temperature treatment to generate a surface barrier layer is considered essential in these approaches. In order to reduce the charring effects that occur, EP 1 780 241 A1 suggests the use of nanoscale fillers.

EP3115407A1 relates to thermostabilized polyamide-based compositions based on iron oxalate and dipentaerythritol in combination with each other for the temperature range above 180° C.

EP 3059283 discloses a variety of polyamide compositions having improved heat resistance for electrical applications, in which a substance having a polyol structure is included that has at least one epoxy group or carbodiimide group. This provides a coupling reaction with the polyamide that is essential to the technology disclosed in EP 3059283. The tendency of polyols to migrate into polyamide is minimized by the reactive coupling to the polyamide matrix. However, the preparation of such polyols with an additional reactive epoxy group or carbodiimide group is complex and cost-intensive and has therefore not become established in practice. Polyol components chemically coupled directly to the polyamide matrix are also disclosed in EP 2 829 576 A1.

EP 2881439 describes glass fiber reinforced polyamide composition with improved heat resistance at high temperatures, containing both a polyol and a copolymer defined by MFI of olefin with at least one methacrylic ester or acrylic ester. In the above example, the polyamide material is aged at 200° C. Similar compositions are also disclosed in EP 2 878 630 A1. Here, however, it is considered essential that the polyamide composition necessarily contains partially aromatic polyamides or polyamide 4/6. However, no reference to stabilization in the sense of the invention described below by iron compounds or reinforcing materials, such as glass fibers, is to be inferred from this document.

EP 3093312A1 discloses polyamide compositions with improved heat resistance at high temperatures above 180° C., comprising, in addition to polyamide, a salt of citric acid, dipentaerythritol and at least one filler or reinforcing agent.

CN 108070253 A discloses polyamide compositions. In this context, stabilization at high temperatures of 200° C. or more is required. The compositions described must therefore contain nanoparticles with a specified particle size. Furthermore, halogen-containing and/or copper-containing stabilizers are used. An indication that, as indicated in the following description of the present invention, iron compounds and/or reinforcing agents, in particular in compositions free of copper-containing and/or halogen-containing stabilizers, exhibit a stabilizing effect is not to be inferred from this document. JP 2019116607 A describes compositions with good surface gloss. The use of halogen-containing components, in particular alkaline earth halides, is essential here.

Another type of polyamide compositions where stabilization at elevated temperatures is a particular challenge are the impact modified polyamides. In these, due to the presence of both a polyamide component and a rubber-elastic polymer component, the particular challenge is to achieve temperature stabilization despite the chemically very different essential polymer components. This problem is particularly pronounced at temperature loads above 140° C.

### TASK OF THE INVENTION

Due to the ever-increasing range of applications of plastic-based materials, e.g. in the automotive sector, better stabilizing components are sought, especially for continuous service temperatures in the range from 100° C. to 170° C., such as 150° C. in particular, especially also for polyamides, in particular polyamides with aliphatic units. A typical requirement from practice for unreinforced polyamides in this context is that when polyamide materials are heat-aged at 150° C., the half-life of the tensile strength is at least 2,000 h, or even after at least 3,000 hours, depending on the application. In combination with this, other requirements to be met are no or only a slight influence on electrical properties, such as tracking resistance, as well as no increased tendency to corrosion. These points are very important for use in the electrical and electronics industry. The expansion in the field of electromobility is additionally increasing the demand for materials that meet the special requirements in this area. For example, ionic stabilizer systems must be largely dispensed with, although the requirements in terms of thermal stability remain high or are even becoming stricter. The stability of polyamides must be ensured over a long period of time, especially with product properties relevant for electrical applications, while thermal stability is required up to the range of higher temperatures (rapid discharge of batteries etc. releases large amounts of heat). These requirements, which are not achievable with conventional systems (and in some cases are contrary), must be reliably met for the expansion of electromobility. With regard to improving the stabilization of reinforced essentially aliphatic polyamides under load at temperatures in the range 100 to 170° C. (typical value 150° C.), one requirement from practice is that, when reinforced polyamide materials are heat-aged at 150° C., the tensile strength drops by a maximum of 10% even after 1,000 h. This is a requirement that must be fulfilled in the development of electric vehicles. In combination with this, other requirements to be met are no or only a slight influence on electrical properties, such as tracking resistance, and no increased tendency to corrosion. These points are very important for use in the electrical and electronics industry. Furthermore, good processability and flowability of the reinforced polyamide materials are also required.

On the other hand, there is a need for systems to stabilize impact-modified polyamides, particularly at elevated temperatures above 140° C.

Therefore, the present invention sets itself the task of indicating a way by which the desired stabilization can be achieved at the above-mentioned continuous service temperatures, i.e., in particular, to enable polyamide compositions that exhibit improved long-term stabilization against heat over a wide range (including at high temperatures above 150° C. and up to 170° C., and in a special case also above 170° C.), and at the same time are also efficiently stabilized at temperatures below 150° C. with respect to a significant extension of the possible service life, preferably with respect to at least one option from a) to c), in particular both a) and b), as well as c), optionally c) and b):
a) with simultaneous suitability for electrical applications (low content of ionic components);
b) and in terms of suitability for both reinforced and unreinforced polyamides;
c) just as with impact-modified polyamides.

It is also important that these tasks are solved in such a way that problem-free application is also possible on an industrial scale. This includes, for example, that undesirable deposit formation, which is known from the use of polyols, but also from other additives in the polyamide sector, is suppressed as far as possible. On the one hand, such deposit formation can occur on the polyamide moldings produced, which, in addition to aesthetic impairments, can also lead to a reduction in the stabilizing effect (since the substances can no longer perform their function); on the other hand, deposit formation can also occur on the devices used in production, which can lead to production disruptions (for example, by shortening production cycles because production has to be stopped to clean the device. Such problems should not occur with the technical solution to the tasks described here, or only to an acceptable extent.

### BRIEF DESCRIPTION OF THE INVENTION

This task is solved by the subject matter of claims 1 and 2, as well as by the subject matter of the subsidiary claims. Preferred embodiments are indicated in the subclaims, as well as in the following description.

The following description contains in particular a detailed description with respect to unreinforced as well as reinforced substantially aliphatic polyamide materials. The skilled person will understand that these descriptions are also applicable and valid in an analogous manner with respect to the claimed and disclosed use, as well as with respect to the described processes. Likewise, the skilled person will understand that these embodiments also apply to partially aromatic polyamides as well as to impact modified polyamides.

### DETAILED DESCRIPTION OF THE INVENTION

Surprisingly, the present invention enables the desired stabilization of polyamides by using components already known, but previously known in the prior art in other contexts or for other processes. Nevertheless, a significantly improved stabilization can be achieved at continuous service temperatures of 100° C. to 170° C., in particular 150° C., with simultaneous suitability for electrical applications. At the same time, the stabilizers to be used according to the invention are readily dispersible in polyamides, so that ease of handling is ensured. The stabilizers according to the invention can be introduced into and dispersed in polyamides by conventional methods, and furthermore the stabilizer components can be easily compounded for use, for example by compounding with a matrix of common materials such as waxes or polymers. Thus, the present invention enables the following advantages to be realized:
1. Improvement of the stabilization of unreinforced and reinforced polyamides against long-term stress at the temperatures mentioned. To delay degradation and the associated reduction in service properties as long as possible, in particular to maintain the mechanical properties as long as possible.
2. This can be realized with essentially aliphatic but also with partially aromatic polyamides. At the same time, the principles described here are also applicable to polyamides that have been impact modified by the addition of suitable components (rubber-elastic components as blend components or grafted polyamides).
3. The stabilized polyamides can be used in particular in electrical applications where high demands are made with regard to the absence of ionic components (such as copper salts, halogen-containing alkali metal salts, etc.).
4. The amount of stabilizer used or the type of stabilizer mixture can be adapted to the desired stabilization time (service life of the product) and to the specific requirements with regard to the presence or absence of ionic components. Due to the very good stabilization provided by the components essential to the invention, it may become possible, for example, to use small amounts of copper stabilizers to achieve a further improvement in stabilization without the electrical properties (tracking resistance) suffering too much due to the very small addition of these components. This can be realized in particular when using copper complexes.
5. Due to the improved stabilization, components can be thinner if necessary, since a material thickness previously considered necessary (due to a desired redundancy or a corresponding safety coefficient) can be reduced (since the polyamides stabilized according to the invention can be loaded for longer even at lower material thicknesses).

Surprisingly, improved stabilization can be achieved when using a polyol compound or an iron compound without having to use the activation by high-temperature treatment described as necessary in the prior art to generate a barrier layer. This is particularly advantageous because it allows the production of very thin components for which the generation of a barrier layer (charring of the surface) is not possible, as otherwise there would be an unacceptable impairment of the mechanical properties.

Essential to the invention is, on the one hand, the use of a polyol component, preferably a polyol with 2 or more hydroxyl groups, preferably a polyol with 2 to 12 hydroxyl groups and a molecular weight of 64 to 2000 g/mol, particularly preferably pentaerythritol, dipentaerythritol and tripentaerythritol (and mixtures thereof), especially dipentaerythritol. In another preferred embodiment, the polyol is a dendritic polymer having terminal OH groups. The molecular weight of such a dendritic polymer is preferably in the range 1000 to 2000 g/mol. The number of hydroxyl groups in this case is preferably in the range of 6 to 60 hydroxyl groups. An example is hydroxy-functional dendritic polyesters formed by polymerization of a polyalcohol core with 2,2-dimethylol-propionic acid, which have good thermal stability. In a further embodiment, alditols and cyclitols can also be used as polyol compounds, with mannitol, erythritol and myo-inositol being preferred.

The second alternative according to the invention is the use of an iron compound, preferably an iron(II) compound, in particular iron oxalate.

According to the invention, these components are used either with a reinforcing agent described herein or, in the case of using a polyol compound, with a copper- and halogen-free antioxidant or with a reinforcing agent described herein and additionally with a copper- and halogen-free antioxidant.

The amount of polyol component used is usually in the range from 0.1 to 7 wt. % (all figures, including those given below, e.g. for the iron compound, based on the total compound), preferably 0.5 to 5 wt. %, particularly preferably 1 to 4 wt. %, especially 1 to 3 wt. %.

The amount of iron compound used is usually in the range of 0.1 to 1 wt. %, in particular 0.2 to 0.6 wt. %.

According to the invention, the use of a polyol component is preferred.

The copper- and halogen-free antioxidant is preferably a secondary aromatic amine or a sterically hindered phenol, which is commonly used in combination with phosphites (such a combination is also referred to hereinafter as a phenolic antioxidant, or such combinations are included when a sterically hindered phenol is mentioned as an antioxidant). Combinations of copper and halogen-free antioxidants are also possible. However, it is preferred to use either a secondary aromatic amine or a sterically hindered phenol (typically in combination with a secondary antioxidant such as phosphites) alone, without further copper- and halogen-free stabilizers.

Secondary aromatic amines used in the present invention can be both monomeric and polymeric secondary aromatic amines. Preferably, the molecular weight of these components is 260 g/mol or more, more preferably 350 g/mol or more. Secondary aromatic amines are compounds in which the amine nitrogen atom is linked to two organic substituents, at least one, preferably both, of which are aromatic. Suitable examples are 4,4′-di(dimethylbenzyl)diphenylamine (commercially available for example under the name Naugard 445), para-(paratoluensulfonylamido)diphenylamine (commercially available for example under the name Naugard SA), the reaction product of diphenylamine with acetone (commercially available, for example, under the name Aminox), N,N′-di-(2-naphthyl)-p-phenylenediamine, 4,4′-bis(-methylbenzyhydryl)diphenylamine and other compounds known to those skilled in the art, for example disclosed in EP 0 509 282 B1.

However, aminic stabilizers in which both an aromatic and an aliphatic substituent are present are also suitable, for example alkyl-aryl-substituted amines or alkyl-aryl-substituted phenylenediamines. Examples include p-phenylenediamines, such as N-(1,3-dimethylbutyl)-N′-phenyl-p-phenylenediamine, or N-phenyl-N′-isopropyl-p-phenylenediamine. In the context of the present invention, systems based on 2,2,4-trimethyl-1,2-dihydroquinoline (TMQ) can also be used, preferably polymerized TMQ. Also possible are condensation products of diphenylamines, such as alkylated diphenylamines or arylated diphenylamines with ketones and/or aldehydes. Condensation products that can also be oligomeric or polymeric are preferred, e.g. from diphenylamines with acetone or from diphenylamines with acetone and formaldehyde.

In this context, it is surprising that these amines show better results than, for example, the known HALS stabilizers.

The amount of secondary aromatic amine used is usually in the range from 0.05 to 3% by weight (all data based on the amount of polyamide used), preferably 0.1 to 2% by weight, particularly preferably 0.25 to 1.5% by weight, especially 0.5 to 1.25% by weight.

Suitable sterically hindered phenols are compounds in which space-filling substituents are present adjacent to the phenolic OH group, for example tert-butyl groups. A particularly suitable example of such stabilizers is 2,6-di-tert-butyl-methylphenol. However, other such stabilizers can of course also be used, including dimeric structures, i.e. two phenolic groups linked by a suitable organic moiety, such as 2,2′methylene-bis(6-t-butyl-4-methyl-phenol) etc. , and also bifunctional phenols, thio-bis-phenols, such as 4,4′thio-bis-6(t-butyl-metacresol), multifunctional phenols, polyphenols, such as reaction products of butylated p-cresol with dicyclobutadiene.

The amount of phenol component used is usually in the range from 0.01 to 3% by weight (all data based on the amount of polyamide used), preferably 0.1 to 2% by weight, particularly preferably 0.25 to 1.5% by weight, especially 0.5 to 1.25% by weight.

The fillers and reinforcing materials to be used according to the invention may be in the form of fibers or particles (or any transitional forms). Organic and inorganic fillers and reinforcing materials can be used. Preferred examples include glass fibers, carbon fibers, glass beads, ground glass, diatomaceous earth, wollastonite, talc, kaolin, layered silicates, CaF₂ , CaCO₃ and aluminum oxides. It is also possible to use nanoscale materials, especially those where for one dimension the D50 value is less than 900 nm.

Suitable nanoscale fillers are substances that can be added at any stage of the production process and can be finely dispersed in the nanometer range. The nanoscale fillers which can be used according to the invention can be surface-treated. However, untreated fillers or mixtures of untreated and treated fillers can also be used. The nanoscale fillers preferably have a particle size of less than 500 nm in at least one dimension. The fillers are preferably minerals which already have a layer structure, such as phyllosilicates and double hydroxides.

The nanoscale fillers used according to the invention are preferably selected from the group of oxides, oxide hydrates of metals or semimetals. In particular, the nanoscale fillers are selected from the group of oxides and oxide hydrates of an element selected from the group of boron, aluminum, calcium, gallium, indium, silicon, germanium, tin, titanium, zirconium, zinc, ytrium or iron.

In a particular embodiment of the invention, the nanoscale fillers are either silicon dioxide or silicon dioxide hydrates. In the polyamide molding compound, in one embodiment, the nanoscale fillers are present as a uniformly dispersed, layered material. Before incorporation into the matrix, they have a layer thickness of 0.7 to 1.2 nm and an interlayer spacing of the mineral layers of up to 5 nm.

Preferred minerals according to the invention which already have a layered structure are natural and synthetic layered silicates and double hydroxides such as hydrotalcite. Also suitable according to the invention are nanofillers based on silicones, silica or silsesquioxanes.

Layered silicates in the sense of the invention are understood to be 1:1 as well as 2:1 layered silicates. In these systems, layers of SiO₄-tetrahedra are linked with those of M(O,OH)₆-octahedra in a regular manner. M stands for metal ions such as Al, Mg, Fe. In the case of 1:1-layer silicates, one tetrahedral and one octahedral layer are connected with each other. Examples are kaolin and serpentine minerals.

In the 2:1 phyllosilicates, two tetrahedral layers are combined with one octahedral layer. If not all octahedral sites are occupied by cations of the required charge to compensate for the negative charge of the SiO₄-tetrahedra as well as the hydroxide ions, charged layers occur. This negative charge is compensated by the incorporation of monovalent cations such as potassium, sodium or lithium or divalent ones such as calcium into the space between the layers. Examples of 2:1 layered silicates are talc, vermiculite, illite as well as smectite, whereby the smectites, to which montmorillonite also belongs, are easily swellable with water due to their layer charge. Furthermore, the cations are easily accessible for exchange processes.

The nanoscale fillers are preferably selected from the group of natural and synthetic phyllosilicates, in particular from the group of bentonite, smectite, montmorillonite, saponite, beidellite, nontronite, hectorite, stevensite, vermiculite, illite, pyrosite, the group of kaolin and serpentine minerals, double hydroxides, or such fillers based on silicones, silica or silsesquioxanes, montmorillonite being particularly preferred.

The fillers and reinforcing materials can also be surface-treated. Surface modifications based on aminoalkylsilanes or aminoalkylsiloxanes or aminoalkyltrialkoxysilanes are particularly preferred.

Particularly preferred is, on the one hand, the use of fiber-like reinforcing materials, in particular glass fibers (especially preferably made of E-glass) and carbon fibers and, on the other hand, the use of glass beads as non-fiber-like reinforcing materials. The use of glass fibers and of glass beads is particularly preferred in the context of the present invention due to their good availability and favorable price basis and, above all, due to their exceptionally good effectiveness. Glass beads and glass fibers can also be used in combination. In this context, the glass fibers are used in particular in the form of short glass fibers for the production of polyamide materials for injection molding and/or extrusion. If the process according to the invention is to be used for the production of high-modulus composites, the glass fibers are preferably used as continuous fibers and/or as long glass fibers. In the case of such composites, the preparation of preconcentrates with the reinforcing material (long glass or continuous glass fibers) described below is naturally not possible. However, the use of other preconcentrates, also with other reinforcing materials, such as short glass fibers, glass beads or other particle-shaped reinforcing materials, is also possible in the production of such composites. Furthermore, several fiber materials can also be used in combination. When using glass spheres, hollow or filled glass spheres can be used. In particular, solid glass spheres, so-called “microspheres” made of borosilicate glass or silicate glass with diameters in the range 5 to 250 μm are used.

It is known from the prior art (and this has also been confirmed in the context of the present invention) that when polyol compounds are used, pronounced migration of the polyol compounds to the surface can occur during aging at temperatures in the range of 90 to 170° C. Such aging tests are a measure of the behavior of the tested materials at service temperatures that occur during the use of the respective polyamide moldings. This migration leads to a strong deposit formation on the surface of the polyamide moldings, fibers, monofilaments or films. These surface deposits have a negative effect on the electrical properties such as the CTI value. In addition, they are visually very unaesthetic and have a disturbing effect on the adhesion properties in the context of bonding, painting or other surface treatments. Due to these problems, the use of polyol compounds at these service temperatures (in the test series: aging temperatures) is often not possible.

It is thus a further object of the present invention to overcome this problem and to provide compositions and polyamide moldings made therefrom which contain, inter alia, polyol compounds, but which nevertheless tend to form surface deposits to a markedly reduced extent under heat aging at <170° C.

Surprisingly, this problem could be solved by either adding to the polyamide, in addition to the polyol compound, a high concentration of glass beads or/and fibrous reinforcing materials, preferably carbon or glass fibers, especially preferably glass fibers (resulting in fiber-reinforced polyamide compositions), or that the polyol compound is first incorporated into a carrier, preferably polymeric carrier, together with either glass beads or with fiber-like reinforcing materials, preferably carbon or/and glass fibers, especially preferably glass fibers. As a particular embodiment, glass beads and glass fibers can also be incorporated simultaneously in the pre-concentrate. In a first step, this preconcentrate is prepared with a carrier, preferably a polymeric carrier, in a manner known to the skilled person. In this process, for example, the polyol compound, a non-copper antioxidant and the glass fibers are introduced into the melt and uniformly distributed in the polymeric carrier. This additive is then mixed into the polyamide to be modified in the melt. This can also be done in the preparation of a high modulus composite with long glass fibers or continuous fibers described above. In the case of the other polyamides to be modified, the content of glass fibers (or carbon fibers or glass beads) can be kept very low in this way, and additional metering of glass fibers or glass beads (to prevent blooming of the polyol compound) during compounding of the polyamide is no longer necessary. This variant leads to polyamide compositions that have such a low proportion of fibers or glass beads that they can be understood as unreinforced polyamide compositions. Here, the addition of the fibers or beads to the pre-concentrate (polyol masterbatch) serves only to prevent migration of the polyol compound to the surface of a molded part under conditions of use that include elevated temperatures.

According to the invention, polyamide and stabilizer components are either melted together and mixed, or compounded by suitable processes (especially when glass fibers or glass beads are used). Alternatively, the polyamide is first melted and then the stabilizer components are mixed in, for example in the form of a blend. In a preferred embodiment, the stabilizer components are added to the melted polyamide in the form of a premix (concentrate or masterbatch).

If a pre-concentrate of the stabilizer components is used, this pre-concentrate can be produced in discontinuously operating mixers that allow very good, homogeneous distribution, for example in a Buss Kneader. Usually, however, continuous mixers are used, such as preferably twin-screw extruders or ZSK extruders. The same polyamide can be used as the matrix material, which is then mixed with the pre-concentrate. However, it is also possible to choose a different polyamide or polymer, or even a non-polymeric material. Optionally, further additives can be added during masterbatch production.

In another preferred embodiment in conjunction with any of the above or below embodiments, the additive according to the invention further comprises at least one additive selected from the group consisting of antioxidants, nucleating agents, stabilizers, lubricants, mold release agents, slip improvers, fillers, colorants, flame retardants and flame retardants, plasticizers, impact modifiers, antistatics, processing aids, and other polymers commonly compounded with polyamides or mixtures thereof. Particularly preferably, the additive additionally contains nucleating agents and/or lubricants. In this way, both the modifying additive and the additives further required for the desired end use can be introduced into the polyamide in a single processing step. This simplifies polyamide processing, since additional mixing-in processes and mixing steps can be omitted.

In a preferred embodiment in connection with any of the above or below embodiments, the pre-concentrate is provided in the form of a mixture of the additive(s) with a carrier. Preferably, the carrier is a polymeric carrier that is readily incorporated into the polyamide to be modified and is readily dispersed or dissolved therein . . . . In addition, the polymeric carrier is preferably thermally stable at the processing temperatures typical for polyamides, contains or forms as few volatile components as possible and does not discolor during processing. Preferably, the polymeric support is selected from a polymer or copolymer of the monomers ethylene, propylene or other olefins, methacrylic acid, vinyl acetate, acrylic acid, acrylic acid ester, or methacrylic acid ester. Particularly preferred is the polymeric carrier an ethylene-vinyl acetate copolymer (EVA) or an olefin-acrylic acid ester copolymer or an olefin-methacrylic acid ester copolymer, especially an ethylene-methyl acrylate copolymer (EMA), an ethylene-ethyl acrylate copolymer (EEA) or an ethylene-butyl acrylate copolymer (EBA). Particularly preferred as a carrier is an ethylene-methyl acrylate copolymer (EMA) or an ethylene-vinyl acetate copolymer (EVA). It has been surprisingly shown that by using a copolymer described herein as a carrier for the preconcentrate, the migration tendency of the polyol component can be significantly reduced. This effect is particularly pronounced, and therefore preferred in the context of the present invention, when the copolymers described herein are used as a carrier component for a polyol-containing preconcentrate.

In one embodiment, the carrier is a polyamide, whereby all common polyamides are possible, preferably PA6 or PA6.6.

As a further embodiment, polymeric support materials with reactive groups can also be used, such as maleic anhydride or glicydyl methacrylate-containing copolymers with olefins. Examples are ethylene-ethyl acrylate-glycidyl methacrylate terpolymer (E-EA-GMA), ethylene-butyl acrylate-glycidyl methacrylate terpolymer (E-BA-GMA), ethylene-vinyl acetate copolymer functionalized with maleic anhydride (E-VA-MA), styrene-ethylene-butylene-styrene copolymer functionalized with maleic anhydride (SEBS-MA).

Unexpectedly, it has been shown that when such polymers are used, in particular copolymers of olefins and either vinyl acetate, or acrylic acid esters or methacrylic acid esters, the formation of deposits on manufactured polyamide workpieces is reduced, which is advantageous because, on the one hand, possibly disturbing deposits on the workpieces can be suppressed, and on the other hand, no residues occur in the molding tools during the manufacture of the polyamide workpieces, so that long production times without cleaning become possible.

In another embodiment, non-polymeric carriers may also be used. Examples include lubricants such as primary and secondary fatty acid amide waxes, for example ethylene bis-stearamide (EBS), erucamide and stearamide, metal soaps for example metal stearates, kerosene waxes, polyolefin waxes, Fischer-Tropsch waxes, fatty acid esters of pentaerythritol, polar synthetic waxes (for example, oxidized polyolefin waxes or grafted polyolefin waxes) or other waxes, and other substances also known as additives for polyamides. Preferred are EBS, erucamide, long-chain esters of pentaerythritol, and oxidized polyolefin waxes.

In a preferred embodiment, the carrier, preferably polymeric carrier, ideally has a melting point that is lower than the melting point of the polyamide to be processed. On the one hand, this enables the additives to be introduced into the carrier in a gentle and energy-saving manner during the production of the preconcentrate and, furthermore, it also simplifies the introduction into the polyamide.

However, it is also possible to add the stabilizing components already during the production of the polyamide, i.e. the monomer mixture. This enables very good mixing without an additional mixing process, which reduces production costs and times.

However, the additives and/or additives mentioned can also be used separately in the process according to the invention, for example by separate metering in during the production of polyamides stabilized according to the invention.

According to the invention, all common polyamides can be stabilized and used within the scope of the invention. Polyamides are polymers with recurring carbonamide groups —CO—NH— in the main chain. They are formed from
(a) aminocarboxylic acids or their functional derivatives, e.g. lactams; or from
(b) diamines and dicarboxylic acids or their functional derivatives.

Due to variations of the monomer building blocks, polyamides are accessible in great variety. The most important representatives are aliphatic polyamides, for example polyamide 6 made from ε-caprolactam, polyamide 6.6 made from hexamethylenediamine and adipic acid, polyamide 6.10 and 6.12, polyamide 10.10, polyamide 12.12, polyamide 11, polyamide 12, PACM-12 as well as polyamide 6-3-T, PA4.6 and partially aromatic polyamides (polyphthalamides PPA), such as e.g.PA6T, PA6T/6I or PA6T/6.6, for example. Within the scope of the present invention, impact-modified polyamides can also be used, whereby this includes both grafted polyamides and blends of polyamides with modifying components (such as rubber-elastic polymers).

Impact modified polyamides to be used in the present invention are, in particular, polyamides compounded with impact modifiers, elastomers and/or rubbers. Examples of such components include EPM or EPDM rubbers, elastomeric copolymers of ethylene and acrylic monomers, ABS, ASA, NR, SES, SEBS or SIS elastomers, butadiene-based elastomers, isoprene-based elastomers, silicone rubbers, and mixtures thereof. These elastomeric impact modifiers are present in the mixing ratios with the polyamide known to those skilled in the art.

According to the invention, however, all other polyamides can also be stabilized, for example other copolyamides or copolymers of polyamides with other segments, for example with polyesters. It is also possible to stabilize blends of different polyamides and blends of polyamides with other polymers. Polyamide 6, polyamide 6.6 and copolyamides of polyamide 6 and polyamide 6.6 are particularly preferred.

Thus, the present invention provides a system that can safely stabilize polyamides over a wide temperature range, said temperature range including temperatures of below 150° C. and likewise temperatures of 150° C. or higher. In particular, the temperature range of 150° C. or higher extends over temperatures of 160° C. or higher, including 170° C. Thus, the present invention enables stabilization to be achieved over the desired temperature range (100° C. to 170° C.) while eliminating the need for copper compounds, as well as halogen compounds, while at the same time eliminating the need for the high temperature treatment described in the prior art to produce a barrier layer. Stabilized polyamide compositions of this aspect of the present invention therefore preferably comprise as stabilizer exclusively the copper and halogen free systems for temperature stabilization described herein. Nevertheless, even within the scope of the present invention, the use of such components is not excluded in fields of application that allow it. Thus, as evidenced in particular by the following experimental data, an overall improved system is provided, so that significant extensions of the stabilization periods can also be realized.

In a further embodiment, the polyalcohols can also be combined with copper stabilizers, preferably based on copper complexes (particularly preferably based on copper complexes in combination with nonionic halogen-containing synergists). This additionally allows improved long-term stabilization even at temperatures above 160° C. In this case, too, an upstream sealing process to form a protective layer is not necessary. Furthermore, this combination allows formulations with low copper and halogen contents in the material to be designed so that the electrical properties of corresponding materials are only slightly or not at all negatively affected. This applies in particular when copper complexes and organic halogen compounds are used, since these have the least (adverse) effect on the electrical properties.

With the polyamide compositions stabilized according to the invention based on the essential components described herein, a very high tracking resistance is also achieved at the same time. In addition, this high tracking resistance is not negatively affected even after heat aging. This also permits use in areas that require high tracking resistance in the form of a CTI (comparative tracking index) value of 600 V (for unreinforced polyamides). This is demonstrated by the tests described below, which evaluate the blooming of the polyol component.

What is surprising in the context of the present invention is that by combining a polyol component with a specific synergist, i.e., a reinforcing agent or a halogen- and copper-free antioxidant, as defined in claims 1 to 9, an unexpected improvement in the stabilization of polyamides can be achieved, which both surpasses classical copper stabilizers and cannot be achieved with other combinations. This is also demonstrated in particular in the following examples, where conventional systems, as well as the iron-based stabilizers described in the prior art, do not allow the effects to be achieved with the combination according to the invention.

The copper stabilizers to be optionally used according to the invention can be freely selected. Typical examples include two essential components, namely a mixture of copper compounds and special halogen-containing compounds (also referred to here as synergists). The copper compound used can be any copper salt (CuI, CuBr, copper acetate, CuCN, copper stearate,) or any other copper compound such as CuO, Cu₂ O, copper carbonate or any complex of copper. The synergist to be used according to the invention is a halogen-containing component, such as a halogenated polymer, an alkali or alkaline earth salt (such as KI, KBr, etc.), or an organic compound with halogen substituents, such as halogen-containing aromatic or aliphatic phosphates.

These two components are typically used in amounts to give a Cu : halogen ratio of 1:1 to 1:50 (molar ratio), preferably 1:4 to 1:20, more preferably 1:6 to 1:15.

The amounts of copper as well as halogen in the polyamide are selected depending on the desired use of the polyamide as well as the desired additional stabilization. The amount of copper used is not limited, as long as the mechanical properties of the polyamide are not negatively affected. However, with regard to the provision of stabilized polyamides with good properties with respect to electrical applications, which is the main focus of the present invention, such additional copper stabilizers are optionally used only in small amounts to achieve particularly good stabilization. In conventional stabilizations, copper amounts of in the range of 1 to 1000 ppm Cu, preferably 3 to 200 ppm Cu, more preferably 5 to 150 ppm Cu are used. In the context of the present invention, the input amounts of copper will normally be in the lower ranges, i.e., preferably 200 ppm or less, more preferably 150 ppm or less, more preferably 100 ppm, 75 ppm, or 50 or less. The feed amounts of synergist (each based on ppm halogen) thus result from the ratios disclosed above. The addition amount for the synergist is not subject to any particular limitation. However, additions above 1% generally do not improve the stabilizer effect. The amounts used are typically in the range of 10 to 10,000 ppm. Preferred amounts are in the range of 30 to 2000 ppm, more preferably 50 to 1500 ppm.

Optional copper complexes to be used according to the invention are complexes of copper with ligands such as triphenylphosphines, mercaptobenzimidazoles, glycine, oxalates and pyridines, Also applicable are chelate ligands such as ethylenediaminetetraacetates, acetylacetonates, ethylenediamines, diethylenetriamines, triethylenetetraamines, phopsphine chelate ligands or bipyridines. Examples of the preferred phosphine chelate ligands are 1,2-bis-(dimethylphosphino)-ethane, bis-(2-diphenylphosphinoethyl)-phenylphosphine, 1,6-(bis-(diphenylphosphino))-hexane, 1,5-bis-(diphenylphosphino)-pentane, bis-(diphenylphosphino)methane, 1,2-bis-(diphenylphosphino)ethane, 1,3-bis-(diphenylphosphino)propane, 1,4-bis-(diphenylphosphino)butane and 2,2′-bis-(diphenylphosphino)-1,1′-binaphthyl.

These ligands can be used individually or in combination to form complexes. The syntheses required for this are known to those skilled in the art or described in the literature on complex chemistry. As usual, these complexes may contain typical inorganic ligands, such as water, chloride, cyanoligands, etc., in addition to the ligands mentioned above.

Preferred are copper complexes with the complex ligands triphenylphosphines, mercaptobenzimidazoles, acetylacetonates and oxalates. Tri phenylphosphines and mercaptobenzimidazoles are particularly preferred.

Preferred complexes of copper used in the invention are usually formed by reaction of copper(I) ions with the phosphine or mercaptobenzimidazole compounds. For example, these complexes can be obtained by reaction of triphenylphosphine with a copper(I) halide suspended in chloroform (G. Kosta, E. Reisenhofer, and L. Stafani, J. lnorg. Nukl. Chem. 27 (1965) 2581). However, it is also possible to react copper(II) compounds reductively with triphenylphosphine to give the copper(I) addition compounds (F. U. Jardine, L. Rule, A. G. Vohrei, J. Chem. Soc. (A) 238-241 (1970)).

However, the complexes optionally used according to the invention can also be prepared by any other suitable process. Suitable copper compounds for the preparation of these complexes are the copper(I) or copper(II) salts of hydrohalic acids, hydrocyanic acid or the copper salts of aliphatic carboxylic acids. Examples of suitable copper salts are copper(I) chloride, copper(I) bromide, copper(I) iodide, copper(I) cyanide, copper(II) chloride, copper(II) acetate or copper(II) stearate.

In principle, all alkyl or aryl phosphines are suitable. Examples of phosphines that can be used according to the invention are triphenylphosphine (TPP), substituted triphenylphosphines, trialkylphosphines and diarylphosphines. An example of a suitable trialkylphosphine is tris-(n-butyl)phosphine. In general, triphenylphosphine complexes are more stable than trialkylphosphine complexes. Triphenylphosphine is also economically preferred due to its commercial availability.

Examples of suitable complexes can be represented by the following formulae: [Cu(PPh₃)₃ X], [Cu₂ X₂ (PPh)₃₃], [Cu(PPh₃)X]₄ as well as [Cu(PPh₃)₂ X], where X is selected from CI, Br, I, CN, SCN or 2-MBI.

However, complexes that can be optionally used according to the invention can also contain additional complex ligands. Examples include bipyridyl (e.g., CuX (PPh₃) (bipy), where X is Cl, Br or I), biquinoline (e.g., CuX (PPh₃) (biquin), where X is CI, Br or I), and 1,10-phenanthroline, o-phenylenebis(dimethylarsine), 1,2-bis(diphenylphosphino)ethane and terpyridyl.

The copper salt to be optionally used according to the invention may be any copper salt.

Preferred are salts of monovalent or divalent copper with inorganic or organic acids.

Examples of suitable copper salts are the copper(I) salts, such as CuI, CuBr, CuCl or CuCN, copper(II) salts, such as CuCl₂, CuBr₂, CuI₂, copper acetate, copper sulfate, copper stearate, copper propionate, copper butyrate, copper lactate, copper benzoate or copper nitrate, as well as the ammonium complexes of the above salts.

Furthermore, compounds such as copper acetylacetonate or copper EDTA can also be used. It is also possible to use mixtures of different copper salts. If necessary, copper powder can also be used.

The synergist for the copper components to be optionally used according to the invention is not limited as described above; in addition to alkali halides, in particular KI and KBr, halogenated polymers, organic compounds with halogens as substituents are preferred, such as aromatic halogen-containing compounds, such as brominated polystyrenes or poly(pentabromobenzyl)acrylates and also halogen-containing aromatic and aliphatic phosphates or phosphonate esters, such as tris(haloaromatic)phosphates or phosphonate esters, e. g.e.g. tris(2,4-dibromophenyl)phosphate, tris(2,4-dichlorophenyl)phosphate and tris(2,4,6-tribromophenyl)phosphate.

Examples of halogen-containing aliphatic phosphates are tris(halohydrocarbyl) phosphates or phosphonate esters. Tris(bromohydrocarbyl) phosphates (brominated aliphatic phosphates) are preferred. In particular, in these compounds, no hydrogen atoms are bonded to an alkyl C atom which is in the alpha position to a C atom bonded to a halogen. As a result, no dehydrohalogenation reactions can occur. Example compounds are tris(3-bromo-2,2 bis(bromomethyl)propyl)phosphates, tris (dibromoneopentyl)phosphate, tris(trichloroneopentyl)phosphates, tris(chlorodibromoneopentyl)phosphates and tris(bromodichloroneopentyl)phosphates. Preferred are tris (dibromoneopentyl) phosphate and tris (tribromoneopentyl) phosphate.

Halogenated polystyrenes, in particular brominated polystyrenes, which are substituted with bromine on the aromatic nucleus are particularly preferred here.

However, the present invention, as described above, achieves the desired stabilization through the use of the essential components defined in the claims and above, so that the present invention also enables, in particular, working without copper-containing components and without halogen-containing components. In embodiments, the polyamide compositions stabilized by the present invention are thus free of copper-containing components/compounds; or free of halogen-containing compounds, in particular free of halides of alkali and/or alkaline earth elements; or free of copper-containing components/compounds and free of halogen-containing compounds, in particular free of halides of alkali and/or alkaline earth elements.

A critical issue with regard to the use of polyamides is corrosion, especially electrocorrosion. In this context, halogens, especially bromine and chlorine, but also iodine, are considered harmful to electrical components due to interactions of the halide anions with intermetallic phases. Therefore, a demand for halogen content reduction has become widespread in the electrical and electronics industry. The present invention uses halogen-free stabilizers, so no problems arise in this regard. Even if halogen-containing stabilizers are used in the context of the present invention (as additional stabilizers, e.g. to produce specific property profiles), the quantities used are so low that even in these embodiments there is no need to worry about problems with regard to electrocorrosion, since the good effectiveness means that low dosages can be used so that corresponding limit values can be observed.

The following examples illustrate the invention.

In all examples, polyamide was compounded with the above stabilizers, either directly or as a pre-concentrate in a carrier in a conventional manner, and the mechanical and other properties to be tested were evaluated on test specimens. The aging conditions are indicated in each case.

A polyamide 6.6 from BASF was used (Ultramid A27 E).

Compounding was carried out with a Leistritz ZSE27MAXX-48D twin screw extruder.

The additives were added gravimetrically during compounding.

After drying, standard test bars for determining the mechanical properties (ISO 527) and impact strength (ISO 179/1eU) were produced from the compound on a Demag Ergotech 60/370-120 concept injection molding machine.

The test bars were stored in heat convection ovens at the temperatures given in the examples.

The modulus of elasticity [MPa], tensile strength [MPa] (elongation [%]) and breaking stress [MPa] (elongation [%]) were measured in a tensile test to ISO 527 using a Zwick Z010 static materials testing machine.

The impact strength was measured in accordance with ISO 179/1eU in the Charpy impact bending test using a HIT PSW 5.5J pendulum impact tester.

Chemical compounds and abbreviations used:

Irganox 1098: N,N′-hexane-1,6-diylbis(3-(3,5-di-tert-butyl-4 hydroxyphenylpropionamide))

Irgaphos 168: Tris-(2,4-di-tert.butylphenyl)phosphite

Naugard 445: 4,4′-bis(α,α-dimethylbenzyl)diphenylamine

Chimassorb 944: poly[[6-[(1,1,3,3-tetramethylbutyl)amino]-1,3,5-triazine-2,4-diyl][(2,2,6,6-tetramethyl-4-piperidinyl)imino]-1,6 hexanediyl[(2,2,6,6-tetramethyl-4-piperidinyl)imino]]).

Iron oxalate was used in the form of a 5% masterbatch of ferrous oxalate dihydrate in polyamide 6.

H324: Bruggolen H324, stabilizer based on copper iodide and potassium iodide.

H3386: Bruggolen H3386, Copper complex based stabilizer with organic halogen containing synergist.

Copolymer A: Ethylene methyl acrylate copolymer

Copolymer B: Ethylene butyl acrylate copolymer

Copolymer C: Ethylene-vinyl acetate copolymer

Copolymer D: Ethylene-acrylic acid copolymer

Filler A: calcined silica

Filler B: Montmorillonite

Filler C: Boehmite

Filler D: Glass beads with a particle size in the range 35 μm

### EXAMPLE 1

The additives listed in Table 1 were compounded with PA 6.6 and the half-life of the tensile strength was determined.

TABLE 1
Stabilization of polyamide 6.6. unreinforced, heat aging at 150° C.

| | | Half-life of the tensile | |
|---|---|---|---|
| Type | Composition | strength | |
| | Without stabilizer | 20 | h |
| Comparison | 3% dipentaerythritol | 500 | h |
| Comparison | 0.7% of the mixture (70% | 1.700 | h |
| | Irganox 1098; 30% Irgaphos 168) | | |
| Comparison | 1.0% of the mixture (70% | 1.800 | h |
| | Irganox 1098; 30% Irgaphos 168) | | |
| Comparison | 1.3% of the mixture (70% | 1.700 | h |
| | Irganox 1098; 30% Irgaphos 168) | | |
| Comparison | 0.7% Naugard 445 | 1.900 | h |
| Comparison | 0.7% Chimassorb 944 | 600 | h |
| Comparison | 0.7% of the mixture (70% | 1.500 | h |
| | Irganox 1098; 30% Irgaphos | | |
| | 168) + 0.7% Naugard 445 | | |
| Comparison | 0.4% H3386 | 4.000 | h |
| Comparison | 0.4% H324 | 4.300 | h |
| Invention | 3% dipentaerythritol + | 2.100 | h |
| | 0.7% of the mixture (70% | | |
| | Irganox 1098; 30% Irgaphos 168) | | |
| Invention | 3% dipentaerythritol + | 4.500 | h |
| | 0.7% Naugard 445 | | |
| Comparison | 3% dipentaerythritol + | 900 | h |
| | 0.7% Chimassorb 944 | | |
| Comparison | 3% dipentaerythritol + | 5.200 | h |
| | 0.4% H324 | | |
| Comparison | 0.5% iron oxalate + | 1.500 | h |
| | 0.4% H324 | | |
| Comparison | 0.5% iron oxalate | 150 | h |

The comparative examples in this table show that sufficient (i.e. at least 2,000 h half-life of tensile strength) stabilization of unreinforced polyamides in the prior art could only be achieved with the aid of copper-based stabilizers (H324 and H3386). The efficiency of phenolic or amine-based (secondary aromatic amines) stabilizers alone or in combination is not sufficient for this purpose, even at very high concentrations, which are even counterproductive. The simultaneous requirement for freedom from copper and halogens cannot be met with the comparative variants known to date. Only the combination of polyalcohols with antioxidants according to the invention, which are either phenolic-based or based on secondary aromatic amines, leads to success, with the combination with a secondary aromatic amine alone showing the best results. Polyalcohols alone, on the other hand, show very little effect at 150° C., even at high concentrations. In this temperature range, combinations of polyol and HALS stabilizer are also not suitable to a sufficient extent.

### EXAMPLE 2

The additives listed in Table 2a were compounded with PA 6.6 and the deposit formation was evaluated. For this purpose, the polyamide granules were stored for 68h at 150° C. in a heat convection oven and then the deposit formation was visually evaluated. In the case of the examples according to the invention using the preconcentrates VK1 to VK13, a preconcentrate was first prepared in the respective copolymer A, B, C or D with the compositions given here, which was then compounded with the polyamide.

Preconcentrates:

| Proportion [wt. %] | VK 1 | VK 2 | VK 3 | VK 4 | VK5 | VK 6 | VK 7 | VK 8 | VK 9 | VK10 | VK11 | VK12 | VK13 |
|---|---|---|---|---|---|---|---|---|---|---|---|---|---|
| Dipentaerythritol | 40 | 50 | 56 | 56 | 40 | 40 | 40 | 40 | 28 | 35 | 35 | 56 | 35 |
| Naugard 445 | 14 | | 14 | 14 | 14 | 14 | 14 | 14 | 10 | 14 | 14 | 14 | 14 |
| BRÜGGOLEN ® H3386 | | 7 | | | | | | | | | | | |
| Fiberglass | | | | | | | | 10 | 30 | 10 | 12 | | |
| Copolymer A | 46 | 43 | 30 | | 31 | 36 | 36 | 36 | 32 | 36 | | | |
| Copolymer B | | | | 30 | | | | | | | | | |
| Copolymer C | | | | | | | | | | | 39 | | 39 |
| Copolymer D | | | | | | | | | | | | 30 | |
| Carbon fiber | | | | | | | 10 | | | 5 | | | |
| Filler C | | | | | | 10 | | | | | | | |
| Filler D | | | | | | | | | | | | | 12 |
| Polyamide 6 | | | | | 15 | | | | | | | | |

The pre-concentrates were each produced on a Leistritz ZSE 27 MAXX 48D twin-screw extruder at 100° C. to 180° C. (in an appropriate temperature profile) with a throughput of 10 kg/hr.

TABLE 2a
Evaluation of deposit formation in polyamide 6.6 after aging at 150° C.
using different stabilizers according to the invention and in comparative examples:

| | | Evaluation of the deposit |
|---|---|---|
| | | formation via an index: |
| | | 1 no coating; 5 visible thin |
| | | coating, 10 strong coating on |
| Variants | | the entire surface |
| Comparison | 0.3% H3386 | 1 |
| Comparison | 2% dipentaerythritol | 3 |
| Comparison | 3% dipentaerythritol | 6 |
| Comparison | 2% dipentaerythritol + | 7 |
| | 0.3% H3386 | |
| Comparison | 0.5% Naugard | 1 |
| Invention without the use of a | 2% dipentaerythritol + | 7 |
| preconcentrate | 0.5% Naugard 445 | |
| Invention using a | 4% UK 1 | 3 |
| preconcentrate without filler | | |
| Comparison using a | 4% UK 2 | 3 |
| preconcentrate without filler | | |
| Invention using a | 4% UK 3 | 4 |
| preconcentrate without filler | | |
| Invention using a | 4% VK 4 | 6 |
| preconcentrate without filler | | |
| Invention using a | 4% UK 12 | 7 |
| preconcentrate without filler | | |
| Invention using a | 4% UK 5 | 6 |
| preconcentrate without filler | | |
| Invention using a | 4% UK 6 | 4 |
| preconcentrate including filler | | |
| Invention using a | 4% VK1 0.5% Filler C (added | 4 |
| preconcentrate and separate | separately, not with the | |
| addition of a filler | preconcentrate) | |
| Invention using a | 4% UK 7 | 3 |
| preconcentrate including filler | | |
| Invention using a | 4% UK 8 | 4 |
| preconcentrate including filler | | |
| Invention using a | 5% UK 9 | 2 |
| preconcentrate including filler | | |
| Invention using a | 4% UK 11 | 1 |
| preconcentrate including filler | | |
| Invention using a | 4% UK 10 | 1 |
| preconcentrate including filler | | |
| Invention using a | 4% UK 13 | 1 |
| preconcentrate including filler | | |
| Invention without the use of a | 35% glass fiber + | 1 |
| preconcentrate | 2% dipentaerythritol + | |
| | 0.5% Naugard 445 | |

As the results of the comparative variants in Table 2a show, polyols tend to migrate and bloom during heat storage. This effect was not observed when using secondary aromatic amines alone or when using copper complex-based stabilizers alone. Although the combination of polyols and secondary aromatic amines according to the invention leads to a significantly increased tendency to migration and to significantly stronger formation of deposits on the finished part (index in Table 2a increases from rating 3 to rating 7), the stabilizing effect is very good. The same was observed analogously with the combination of polyols with copper-based stabilizers. The example according to the invention obtained by direct addition of dipentaerythritol and Naugard 445 shows increased deposit formation (rating 7), but is excellent in terms of heat stabilization. Since such deposit formation is a serious problem in many applications, the present invention also aims to solve this problem. It is therefore another crucial additional task of the invention to significantly reduce this increased tendency to migration, as its practicality would otherwise be severely limited. It was found that by using a suitable polymeric preconcentrate, the migration tendency of additives according to the invention in unreinforced polyamides can be significantly reduced during warm storage. As shown by the results in Table 2a using a preconcentrate without filler, the selection of the polymeric carrier is very important for success with regard to reduction of the migration tendency. Thus, with an ethylene-acrylic acid copolymer, no reduction of the migration tendency was achieved, with an ethylene-butyl acrylate copolymer a slight reduction of the migration tendency. In contrast, a significant reduction in the migration tendency was achieved when ethylene-methyl acrylate copolymer was used, as was the case when ethylene-vinyl acetate copolymer was used as the carrier material for the preconcentrate.

Particularly effective and therefore particularly preferred in the context of the invention is therefore the use of a copolymer consisting of an olefin and a methyl acrylate or the use of a copolymer consisting of an olefin and vinyl acetate. Another important measure for minimizing deposit formation is the use of fillers and reinforcing agents, preferably incorporated in the preconcentrate. Preferably, glass beads or fibers are used, particularly preferably glass fibers or carbon fibers. The test results of the variants with the pre-concentrates VK6, VK7, VK8, VK9, VK10, VK11 and VK13 clearly prove this. If no pre-concentrate with filler is used, it has been shown that when added to the polyamide to be modified during compounding, high concentrations of glass fibers (or other fibers or glass beads or fillers) of typically 20-40% have to be used to achieve a significant reduction in deposit formation. The concentration should be above 10% to obtain sufficient effectiveness. Surprisingly, however, it is much more effective in terms of reduction of deposit formation to incorporate glass fibers (or glass beads or carbon fibers, etc.) directly into the preconcentrate. As a result, even at low glass fiber contents of <5%, and even at <2% in each case relative to the finished compound, very good inhibition of the tendency to migrate and thus of deposit formation can be achieved. This also applies analogously to the use of glass beads. Due to the low to very low contents of fillers and reinforcing materials, the finished compounds themselves can be classified as basically unreinforced. Another effective measure for minimizing deposit formation is the combination of glass and carbon fibers or of glass fibers and glass beads in the preconcentrate. The deposit formation can thus be further minimized, while the required fiber content (e.g. <0.5% carbon fibers and <1.0% glass fibers) can also be reduced. Due to the low fiber content, the flow properties can be designed in such a way that, for example, injection molding can be performed very well and with excellent flow properties. This shows that within the scope of the present invention, a modular system is provided which makes it possible to target different requirements. In this context, both the selection of the polymeric carrier material, the selection of the filler/reinforcing material and the concentrations of the components in the preconcentrate are important influencing factors with regard to the results to be achieved, as the results listed show. The suitable selection and combination of polymeric carrier material and filler in the pre-concentrate even completely prevented the formation of deposits during heat storage. Thus, not only the additional migration tendency caused by the combination of polyols with further antioxidants could be suppressed, but the migration tendency was suppressed to such an extent that clearly better results (regarding no deposit formation) were obtained than with the use of polyols alone. In addition, it was shown (as also demonstrated by the results in Table 2b) that these measures massively reducing migration in the context of the present invention do not have any negative influences on the application properties of the finished parts, such as mechanical properties and heat stability.

At the same time, it is confirmed by the experiments that the use of fibrous reinforcing materials (such as glass fibers) or of glass beads, in high concentrations in the compound or in low concentrations in the compound when the fibers (or beads) are added to the preconcentrate, unexpectedly reduces the migration tendency of the additives, in particular of the polyol component, while this effect cannot be achieved to the same extent with other particulate reinforcing materials. Furthermore, by reducing or completely preventing migration of the polyol component, the amount of polyol component used can also be reduced (since no, or at least only very small, amounts are lost to migration) without compromising stabilization. This in turn leads to further reduced migration to the surface (since less polyol component is present in the compound). Excellent property profiles can thus be achieved.

TABLE 2b
Stabilization of unreinforced polyamide 6.6 mainly
with additives according to the invention in the
form of preconcentrates; heat aging at 150° C.

| | | | Apparent |
|---|---|---|---|
| | | | viscosity |
| | | Half-life of | [Pas] at |
| | | tensile strength | shear rate |
| | | after heat | 1000s⁻¹ |
| Variants | | aging at 150° C. | (unaged) |
| Invention | 1.6% dipentaerythritol + | 2.500 h | 50 |
| | 0.65% Naugard 445 | | |
| Invention | 4% UK 1 | 2.600 h | 50 |
| Invention | 4% UK 7 | 2.700 h | 50 |
| Invention | 4% UK 8 | 2.700 h | 55 |
| Invention | 5% UK 9 | 2.800 h | 50 |

The results of heat aging at 150° C. presented here show that the use of polymeric preconcentrates (including the additional use of fillers) achieves heat stabilization similar to that achieved by direct use of the individual stabilizing components in the compound. This means that, as described above, the formation of deposits during heat aging can be massively reduced by using fillers in the pre-concentrate, without any loss of stabilization efficiency.

By means of HKR (high pressure capillary viscometer) the flowability of the variants was determined. The results show that the apparent viscosity relevant for the injection molding process (at shear rate 1000 s⁻¹) and thus the flowability of the resulting polyamide materials remain at the same level even with the addition of fibers or other fillers in the preconcentrate (VK9 contains 30% glass fibers) and are not deteriorated compared to variants without the addition of fillers. The usability of even the pre-concentrates with reinforcing materials, such as glass fibers or carbon fibers, is therefore very good for processing the resulting polyamide materials in injection molding and extrusion.

### EXAMPLE 3

The additives listed in Table 3 were compounded with PA 6.6 and the time until the tensile strength drops to 90% of the initial value was determined.

TABLE 3
Stabilization of unreinforced and reinforced
polyamide 6.6; heat aging at 120° C.
Experiments with dipentaerythritol and ferric oxalate
(inventive combinations and comparative variants);

| | | Time until 90% of tensile | |
|---|---|---|---|
| Type | Composition | strength is reached | |
| | Without stabilizer, | 100 | h |
| | without GF | | |
| Comparison | 2.5% Dipentaerythritol, | 600 | h |
| | without GF | | |
| Comparison | 0.5% iron oxalate, | 50 | h |
| | without GF | | |
| Comparison | without stabilizer, | 500 | h |
| | with 35% GF | | |
| Invention | 0.5% iron oxalate, | >4.700 h | |
| | with 35% GF | (value at 4.700 h 93%) | |
| Invention | 0.3% iron oxalate, | >4.700 h | |
| | with 35% GF | (value at 4.700 h 92%) | |
| Invention | 2.5% dipentaerythritol, | 1800 | h |
| | with 35% GF | | |

At comparatively lower temperatures, such as 120° C. in this case, polyalcohols as well as iron oxalate alone in polyamides show only a minor effect on the material lifetime. The same applies when glass fibers alone or fillers alone are used. Surprisingly, a process with a suitable combination of polyols or iron compounds and glass fibers achieves a clearly synergistic effect and a significant improvement in long-term stability even at temperatures in the range of 100 to 170° C., and this surprisingly without a preceding “sealing” step. In this context, it has further been shown that an improvement in flow properties occurs due to the use of the polyol component, even when glass fibers or glass beads are used in the pre-concentrate (to prevent migration in the finished part), so that no disadvantages are observed even with regard to processing/shaping due to the use of fibers or beads in the pre-concentrate (which leads to a certain amount of fibers or beads in the compound).

### EXAMPLE 4

The additives listed in Table 4 were compounded with PA 6.6 and the time until the tensile strength drops to 90% of the initial value after heat aging was determined.

TABLE 4
Stabilization of unreinforced and reinforced
polyamide 6.6; heat aging at 170° C.
Experiments with dipentaerythritol
(inventive combination and comparative variants);

| | | Time until 90% of tensile | |
|---|---|---|---|
| Type | Composition | strength is reached | |
| | Without stabilizer, | <20 | h |
| | without GF | | |
| Comparison | 2.5% dipentaerythritol, | 1.200 | h |
| | without GF | | |
| Comparison | without stabilizer, | 550 | h |
| | with 35% GF | | |

| | | |
|---|---|---|
| Invention | 2.5% dipentaerythritol, | >3.000 h; 98% after |
| | with 35% GF | 3.000 h |

When the storage temperature is increased from 120° C. as in Example 3 to 170° C. in Example 4, it can be seen that when dipentaerythritol alone is used in unreinforced polyamide, there is a longer lifetime of the polyamide material compared to the lower temperature of 120° C. This behavior is fundamentally different from the effect of the known antioxidants, for which, according to the textbook, the Arrhenius equation is valid and thus the logarithmic values of the retention times decrease linearly with the reciprocal temperature (1/T). This principle is used for rapid aging tests to predict lifetimes at lower temperatures from data at high temperatures. However, Tables 3 and 4 show that the lower the aging temperature, the less effective polyols are. Only at very high temperatures (in accordance with common doctrine on the formation of a “protective layer”) is a significantly improved effect achieved with regard to the long-term stability of the material. The principle of rapid aging tests is therefore not applicable to materials provided with polyols.

Surprisingly, however, the desired long-term stability of the polyamide materials is also achieved at higher temperatures in the range from 100 to 170° C. if, instead of a higher aging temperature (for the formation of the protective layer), a process is used in which glass fibers and/or fillers are added to the melt at the same time as the polyol during compound production (see Table 4). This is all the more surprising because, although glass fibers or other fillers alone have a positive effect on the long-term stability of the materials, this effect is comparatively low and is usually not sufficient on its own to meet the high requirements in terms of metal replacement in practice, especially in the automotive sector.

### EXAMPLE 5

The additives listed in Table 5 were compounded with PA 6.6 and the tensile strength (in relation to the initial value after compounding) was determined after storage at 150° C. for 2000 h. The tensile strength of PA 6.6 was then determined.

TABLE 5
Stabilization of polyamide 6.6 reinforced: heat aging at 150° C.

| | | Tensile | Tensile |
|---|---|---|---|
| | | strength | strength |
| Type | Composition | after 2000 h | after 5000 h |
| Comparison | Without stabilizer | 50% | 15% |
| | with 35% filler A | | |
| Invention | 2.5% dipentaerythritol | 75% | 73% |
| | with 35% filler A | | |
| Comparison | Without stabilizer | 85% | 70% |
| | with 35% glass fiber | | |
| Invention | 2.5% dipentaerythritol | 90% | 90% |
| | with 35% glass fiber | | |

Table 5 shows that even when using a filler in particulate form (i.e. no fiber form), a significant improvement in heat stability can be obtained, since again the polyol component shows an unexpected synergistic effect with the reinforcing component. However, this synergistic effect is much more pronounced when glass fibers are used and is even more evident with longer storage times. It is essential here, in particular, that according to the invention the tensile strength values are maintained at a high level over a long period of time, while with filler only, but also with glass fibers only, a significant reduction occurs, especially at very long heat aging times (which are rather representative of the actual requirements in use).

### EXAMPLE 6

The additives listed in Table 6 were compounded with PA 6.6 and the time at which the tensile strength drops to 90% of the initial value was determined.

TABLE 6
Stabilization of polyamide 6.6 reinforced
(35% glass fiber content); heat aging at 200° C.
Comparative tests with dipentaerythritol and various antioxidants

| | Time until 90% of the | |
|---|---|---|
| Composition | initial tensile strength is reached | |
| Without stabilizer | 150 | h |
| 1.0% Dipentaerythritol | 670 | h |
| 1.75% dipentaerythritol | 1.100 | h |
| 2.5% dipentaerythritol | 1.600 | h |
| 0.7% Naugard 445 | 150 | h |
| 2.5% dipentaerythritol and | 1.600 | h |
| 0.7% Naugard 445 | | |
| 0.7% of the mixture (70% | 150 | h |
| Irganox 1098; 30% Irgaphos 168) | | |
| 2.5% dipentaerythritol and | 1.600 | h |
| 0.7% of the mixture (70% | | |
| Irganox 1098; 30% Irgaphos 168) | | |
| 0.3% H324 | 250 | h |
| 2.5% dipentaerythritol and | 1.600 | h |
| 0.3% H324 | | |

At high temperatures above 170° C., especially at temperatures above 190° C., the stabilizers typical for polyamides, with the exception of copper stabilizers, show no effect. Even with copper-based antioxidants, the effect is only very slight at temperatures of 200° C. and above. In the case of polyamide compositions with simultaneous use of a polyalcohol, it becomes clear at these very high temperatures that the polyalcohol is decisive for the effect. Additions of further stabilizers do not lead to an extension of the stabilization times.

The importance of additional stabilizers based on phenolic, aminic or copper-based antioxidants for long-term stability is thus negligible at temperatures of 200° C. This is in contrast to the stabilization achieved according to the invention at lower temperatures (see Table 1), where the combination with such further stabilizers shows a surprising and significant effect on the long-term stability of unreinforced polyamide materials in the temperature range from 100 to 170° C. These tests thus prove that the stabilization achievable according to the invention runs counter to the expectations of the person skilled in the art. It was therefore not to be expected by the person skilled in the art that the long-term stabilization achieved in the temperature range according to the invention could actually be realized.

### EXAMPLE 7

The additives listed in Table 7 were compounded with PA 6.6 and the time until the tensile strength drops to 90% of the initial value was determined.

TABLE 7
Stabilization of polyamide 6.6 reinforced with glass fibers; heat aging at 150° C.
Experiments with dipentaerythritol, glass fibers, and additives
(inventive combinations and comparative variants);

| | | Time until 90% of tensile strength | |
|---|---|---|---|
| Type | Composition | is reached | |
| Comparison | without stabilizer, | 550 | h |
| | with 35% GF | | |
| Invention | 2.5% dipentaerythritol, | 1.200 | h |
| | with 35% GF | | |
| Comparison | 0.7% of the mixture (70% Irganox 1098; | 800 | h |
| | 30% Irgaphos 168), with 35% GF | | |
| Invention | 2.5% dipentaerythritol + 0.7% Naugard | 1.500 | h |
| | 445, with 35% GF | | |

The results from Table 7 demonstrate that, contrary to the expectation postulated in the prior art that high-temperature sealing is necessary for polyol-based stabilizer systems to achieve appreciable improvement in stabilization, without high-temperature sealing at high temperatures such as 200° C., the polyol/GF system shows significantly improved stability at a storage temperature of 150° C. The polyol/GF/sec.aromatic amine combination according to the invention also shows excellent stabilization at 150° C.

It is thus clear that only the particular combinations according to the invention show suitability for long-term stabilization of polyamides in the temperature range from 100 to 170° C., while at the same time dispensing with copper-based stabilizers and ionic stabilizer components (such as copper and halogen salts).

TABLE 8
CTI values
Test plates of 3 × 5 cm and 3 mm thickness were produced on the
injection molding machine from the compositions described in Table 8,
and the CTI values particularly relevant for electrical applications
were measured in accordance with the IEC-60112 standard.

| Type | Composition | CTI value |
|---|---|---|
| Comparison | Without | 600 V |
| | stabilizer | |
| Comparison | 3% dipentaerythritol | 600 V |
| Comparison | 0.4% H324 | 475 V |
| Comparison | 0.7% Naugard 445 | 600 V |
| Comparison | 0.7% of the mixture | 600 V |
| | (70% Irganox 1098; | |
| | 30% Irgaphos 168) | |
| Invention | 3% Dipentaerythritol + | 600 V |
| | 0.7% Naugard 445 | |
| Invention | 3% dipentaerythritol + 0.7% of | 600 V |
| | the mixture (70% Irganox 1098; | |
| | 30% Irgaphos 168) | |

The results from Table 8 show that in addition to the improved thermal properties, the influence on the electrical properties, in particular the tracking resistance, remains low. This still allows the use of such stabilizers in the E&E area, where high CTI values are required in addition to increased heat resistance. Likewise, the corrosion effect of various stabilizers, which is critical in many cases, should not be negatively influenced by the composition according to the invention.

1. A process for stabilizing polyamides at temperatures of 100° C. to 170° C. wherein a polyamide is mixed with a polyol compound and a halogen- and copper-free antioxidant.

2. A process for stabilizing polyamides at temperatures of 100° C. to 170° C., wherein a polyamide is mixed with a polyol compound or an iron compound and a reinforcing material.

3. A process comprising use of a polyol compound and a halogen- and copper-free antioxidant for stabilizing polyamides at temperatures from 100° C. to 170° C.

4. A process comprising using a polyol compound or an iron compound and a reinforcing agent for stabilizing polyamides at temperatures of 100° C. to 170° C.

5. The process according to claim 1 wherein the polyol compound is a polyol with 2 to 12 hydroxyl groups and a molecular weight of 64 to 2000 g/mol.

6. The process according to claim 1, wherein a reinforcing material is additionally mixed in.

7. The process of claim 2, wherein a halogen- and copper-free antioxidant is additionally used.

8. The process of claim 7, wherein the halogen- and copper-free antioxidant is selected from at least one of secondary aromatic amines, alkyl-aryl substituted amines, or sterically hindered phenols.

9. The process according to claim 2, wherein the reinforcing material is selected from glass or carbon fibers or glass beads or other fillers, including nanoscale fillers.

10. The process according to claim 1, wherein a copper compound and/or a halogen-containing synergist is additionally used.

11. The process according to claim 10, wherein the copper compound is a copper (I) salt, a copper (II) salt or a copper complex, wherein the copper (I) salt is selected from CuI, CuBr, CuCl, CuCN, Cu₂O or mixtures thereof and/or wherein the copper (II) salt is selected from copper acetate, copper stearate, copper sulfate, copper propionate, copper butyrate, copper lactate, copper benzoate, copper nitrate, CuO, CuCl₂ or mixtures thereof, and/or the copper complex is selected from one or more of copper acetylacetonate, copper oxalate, copper EDTA, Cu(PPh₃)₃X, Cu₂X₂(PPH₃)₃, Cu(PPh₃)X, Cu(PPh₃)₂X, CuX(PPh₃)(bipy) and CuX(PPh₃)(biquin) wherein X=Cl, Br, I, CN, SCN or 2-mercaptobenzimidazole.

12. The process according to claim 10, wherein the halogen-containing synergist is a bromine-containing polymer having aromatic groups.

13. The process of claim 1, wherein the polyamide is an aliphatic or partially aromatic polyamide impact modified in each case, and selected from PA 6, PA 6.6, PA 4.6, PA 11, PA 12 or mixtures thereof.

14. The process according to claim 1, wherein the polyol compound is used together with a halogen- and copper-free antioxidant or the polyol compound is used together with a halogen- and copper-free antioxidant and with a further antioxidant in the form of a pre-concentrate in a polymeric or non-polymeric carrier.

15. The process or use according to claim 14, wherein the preconcentrate additionally contains glass beads or fibrous reinforcing materials or other fillers, and/or the carrier material for the preconcentrate is a polymer selected from polymers or copolymers of the monomers ethylene, propylene or other olefins, methacrylic acid, vinyl acetate, acrylic acid, acrylic acid esters, or methacrylic acid esters.

16. A polyamide material obtainable by a process according to claim 1.

17. The process of claim 1 comprising stabilizing polyamides at a temperature of 150° C.

18. The process of claim 2 comprising stabilizing polyamides at a temperature of 150° C.

19. The process of claim 5 wherein the polyol compound is selected from at least one of pentaerythritol, dipentaerythritol and tripentaerythritol.

20. The process of claim 15 wherein the carrier material for the preconcentrate is a polymer selected from at least one of ethylene-vinyl acetate copolymer (EVA), an olefin-acrylic acid ester copolymer and an olefin-methacrylic acid ester copolymer.
